(19) United States
(12) Patent Application Publication
(10) Pub. No.: US 2008/0092740 A1
(43) Pub. Date: Apr. 24, 2008

(54) Installation for Producing Oxygen of High Purity

(75) Inventors: Olivier Vandroux, Grenoble (FR); Eric Guilbaud, Floirac (FR); Frederic Touvard, Revel (FR); Nicolas Schmutz, Paris (FR); Lionel Balland, Colombe (FR)

Correspondence Address: AIR LIQUIDE;Intellectual Property, 2700 POST OAK BOULEVARD, SUITE 1800, HOUSTON, TX, 77056, US

(73) Assignee: SK Telecom Co., Ltd., Jung-gu, Seoul (KR)

(21) Appl. No.: 11/572,196

(22) PCT Filed: Jun. 16, 2005
(86) PCT No.: PCT/FR05/50448

§ 371 Date: Jun. 29, 2007

(30) Foreign Application Priority Data
Jul. 28, 2004 (FR) 0451678

(51) Int. Cl. B01D 53/047; B01D 53/22

(52) U.S. Cl. 96/4

(57) ABSTRACT

The invention relates to an installation for producing oxygen of high purity, which is advantageously installed in a transportable container (21), comprising: an upstream pressure-swing-adsorption (PSA) device (A₁) containing a zeolite sieve; a downstream PSA device (A₂) containing a carbonaceous sieve; in a loop between the two devices, a permeation device (P) capable of separating oxygen form argon; and a medium-pressure oxygen compressor (20). The invention is used for producing oxygen of high purity on-site, typically in isolated locations.

The present invention relates to installations for producing high-purity oxygen on site, being in particular suitable for consumption sites that are isolated or difficult to supply with bottled high-purity oxygen.

PSA-type adsorption gas separation devices make it possible, in single-stage configuration, to produce oxygen at a purity not exceeding 95%. Systems have been proposed for on-site or on-board installations with, in series, at least one PSA-type adsorption gas separation device coupled to another PSA device or to a permeation gas separation device. The known devices have quite low energy efficiencies and are of sensitive operation.

The subject of the present invention is to provide an installation capable of supplying oxygen at a purity reaching or surpassing 99.5%, of easy operation, therefore allowing a facilitated integration on-site, especially a significant standardization of the sub-components enabling the costs to be reduced, and having a satisfactory energy efficiency.

In order to do this, according to one feature of the invention, the installation comprises:
a first adsorption gas separation device having a first inlet, typically that can be connected to a pressurized air source, and a second outlet, and containing at least one adsorbent capable of retaining nitrogen;
a second adsorption gas separation device having a second inlet connected to the first outlet and a second outlet, and containing at least one adsorbent capable of retaining argon; and
in a branch of a loop between the first outlet and the second inlet, a permeation gas separation device consisting of at least one membrane capable of separating oxygen from argon and having a third inlet connected to the second inlet and an oxygen outlet connected to the first outlet of the first separation device.

According to other features of the invention:
the installation comprises an oxygen compressor placed in the loop, between the first outlet and the second inlet or between the oxygen outlet and the first outlet;
the adsorbent of the first separation device comprises at least one zeolite, typically an X zeolite, advantageously an LiX zeolite, the adsorbent of the second separation device comprising at least one carbon-based molecular sieve;
the installation is operationally installed in a standard shipping container.

Other features and advantages of the invention will emerge from the following description of one embodiment, given by way of illustration but not at all limiting, presented in connection with the appended drawings, in which:
the single figure schematically represents one embodiment of an installation according to the invention built into a transportable enclosure.

On the single figure, a first PSA-type adsorption gas separation device A₁ with zeolite molecular sieve is distinguished, having a compressed air inlet 1 supplied, from an atmospheric air inlet 2, by a low-pressure compression/filtration and drying assembly 3 typically via an air buffer tank 4.

The separation device A₁ consists of an oxygen-enriched mixture outlet 5 discharging into an oxygen buffer tank 6 connected, via a line 7, to the inlet 8 of a second PSA-type adsorption gas separation device A₂ with carbon-based molecular sieve consisting of an oxygen outlet 10 that can be connected to an external user circuit 11 via an oxygen compressor 12, typically high-pressure one.

The first gas separation device A₁ comprises at least one, typically at least two, adsorbers consisting of at least one X-type zeolite molecular sieve, advantageously an LiX lithium zeolite, in order to supply oxygen at a purity between 94 and 95% at the outlet 5.

The second adsorption gas separation device A₂ comprises for its part at least one, typically at least two, adsorbers each consisting of at least one carbon-based molecular sieve capable of separating the residual argon from the enriched oxygen transported by the line 7 in order to supply, at the outlet 10, oxygen at a purity of about 99.5%.

According to the invention, the line 7 is built into a loop B comprising a branch 13 stretching, parallel to the line 7, between the inlet 8 of the second separation device 9 and the outlet 5 of the first separation device 1, typically via a second connection to the tank 6.

According to one aspect of the invention, the branch 13 includes a permeation gas separation device 14 comprising at least one permeable membrane 15 capable of separating oxygen from argon, for example a bundle of polymer membranes sold by MedAl of Wilmington, USA, under the reference “type C or D fiber”. The membrane separation device 14 consists of an inlet 16 connected, typically via a purge gas buffer tank 17 to the inlet of the second separation device 9, an oxygen outlet 18 and an outlet 19 for the purge gas that is mainly made up of argon.

According to one aspect of the invention, a medium pressure oxygen compressor 20 is placed in the loop B, between the oxygen outlet 18 of the permeation device 14 and the buffer tank 6, as in the embodiment represented or, as a variant, in the line 7, between the inlet 8 of the second separation device 9 and the buffer tank 6, the latter being in this case directly connected to the oxygen outlet 18 of the permeation device 14.

In an actual embodiment, for a feed air pressure of about 6.5 bar at the inlet 1 and a medium pressure oxygen flow rate of about 20 Sm³/h at the outlet 5, the compressor 20 is sized in order to supply at the outlet 10 a flow rate of high-purity oxygen of about 6 Sm³/h at an operating pressure of about 3.5 bar.

According to one aspect of the invention, the main components 3, 1, 9, 12, 14 and 20 are produced in the form of individual self-supporting structures consisting of standard fluid inlets/outlets and placed, like the tanks 4, 6 and 17, in a rigid enclosure of transportable form 21, typically a 40-foot ISO shipping container, in order to standardize the assembly and to facilitate the transport and positioning of the installation on site, especially in the context of health procedures in devastated regions, for the supply of medical oxygen.

Although the invention has been described in connection with one particular embodiment, it is not limited thereto but is open to modifications and variants that will be apparent to a person skilled in the art within the scope of the claims below.

1-9. (canceled)

10. An installation for producing high-purity oxygen comprising:
a) a first adsorption gas separation device having a first inlet and a first outlet and containing at least one adsorbent capable of retaining nitrogen;
b) a second adsorption gas separation device having a second inlet connected to the first outlet, and a second outlet and containing at least one adsorbent capable of retaining argon; and
c) in a branch of a loop between the first outlet and the second inlet, a permeation gas separation device consisting of at least one membrane capable of separating oxygen from argon, having a third inlet connected to the second inlet and an oxygen outlet connected to the first outlet.

11. The installation of claim 10, comprising an oxygen compressor placed in the loop.

12. The installation of claim 11, where the oxygen compressor is placed between the first outlet and the second inlet.

13. The installation of claim 11, where the oxygen compressor is placed between the oxygen outlet and the first outlet.

14. The installation of claim 10, comprising a low-pressure air compressor assembly connected to the first inlet.

15. The installation of claim 10, furthermore comprising an oxygen compressor downstream of the second outlet.

16. The installation of claim 10, wherein the adsorbent of the first separation device comprises at least one zeolite.

17. The installation of claim 10, in which the adsorbent of the second separation device comprises at least one carbon-based molecular sieve.

18. The installation of claim 10, wherein it is operationally installed in a shipping container.
